(19) United States
(12) Patent Application Publication
(10) Pub. No.: US 2012/0147278 A1
(43) Pub. Date: Jun. 14, 2012

(54) LIGHTING DEVICE, DISPLAY DEVICE AND TELEVISION RECEIVER

(75) Inventor: Shiyoshi Cho, Osaka-shi (JP)

(73) Assignee: SHARP KABUSHIKI KAISHA, Osaka-shi, Osaka (JP)

(21) Appl. No.: 13/391,482

(22) PCT Filed: Jun. 25, 2010
(86) PCT No.: PCT/JP2010/060808

§ 371 Date: Feb. 21, 2012

(30) Foreign Application Priority Data
Sep. 9, 2009 (JP) 2009-208391

(51) Int. Cl. G02F 1/1335; H04N 3/14; G09F 13/04

(52) U.S. Cl. 348/790; 362/97.1; 349/61; 348/E05.133

(57) ABSTRACT

A lighting device according to the present invention includes a hot cathode tube 17, a chassis 14 storing the hot cathode tube 17 therein, and a heat radiating mechanism 40 configured to come in contact with the hot cathode tube 17 and radiate heat of the hot cathode tube 17. The heat radiating mechanism 40 has a heat radiating sheet 43 configured to contact with the hot cathode tube 17, and a displacing part 42 displacing the heat radiating sheet 43 between a contact position where the heat radiating sheet is in contact with the hot cathode tube 17 and a non-contact position where the heat radiating sheet 43 is not in contact with the hot cathode tube 17. The displacing part 42 displaces the heat radiating sheet 43 to the non-contact position at a temperature that is lower than a predetermined temperature and to the contact position at a temperature that is higher than the predetermined temperature.

### TECHNICAL FIELD

The present invention relates to a lighting device, a display device and a television receiver.

### BACKGROUND ART

For example, a liquid crystal panel used for a liquid crystal display device such as a liquid crystal television set does not emit light by itself, and therefore, requires a separate backlight unit as a lighting device. This backlight unit is installed on the back side of a liquid crystal panel (side opposite to a display surface) and includes a chassis having an opened surface facing the liquid crystal panel, and a light source stored in the chassis (Patent Document 1). A discharge tube such as a cathode tube is used as the light source of the backlight unit having such configuration.

### PRIOR ART DOCUMENT

### Patent Document

Patent Document 1: Japanese Unexamined Patent Publication No. 2006-114445

### Problem to be Solved by the Invention

The brightness of the discharge tube generally varies according to a change in ambient temperature. This is because the temperature of a point where the temperature becomes the lowest in the tube (coolest point) changes with the change in the ambient temperature, resulting that the vapor pressure of mercury filled in the tube changes to cause changes in the light emitting efficiency. Specifically, when the temperature at the coolest point is a specific temperature (proper temperature), the brightness becomes the highest, and when the temperature at the coolest point is lower or higher than the proper temperature, the brightness lowers. For this reason, when the ambient temperature rises due to heat generation during lighting of the discharge tube, the temperature at the coolest point becomes higher than the proper temperature, thereby possibly lowering the brightness.

### DISCLOSURE OF THE PRESENT INVENTION

The present invention is made in consideration of the above-mentioned situation and intends to provide a lighting device configured to suppress lowering of the brightness due to temperature, and a display device and a television receiver that use the lighting device.

### Means for Solving the Problem

To solve the above-mentioned problem, a lighting device according to the present invention includes a discharge tube, a chassis configured to house the discharge tube therein and a heat radiating mechanism configured to come in contact with the discharge tube and radiate heat of the discharge tube. The heat radiating mechanism has a contact part configured to contact with the discharge tube and displacing configured to displace the contact part between a contact position where the contact part comes in contact with the discharge tube and a non-contact position where the contact part is not in contact with the discharge tube. The displacing member displaces the contact part to the non-contact position at a temperature that is lower than a predetermined temperature and displaces the contact part to the contact position at a temperature that is higher than the predetermined temperature.

According to the present invention, when the temperature of the displacing member is lower than the predetermined temperature (at low temperature), the contact part is not in contact with the discharge tube. Therefore, heat of the discharge tube is not radiated toward the contact part. Thus, at low temperature, the temperature of the coolest point (the point where the temperature in the discharge tube becomes the lowest) is not lowered. When the temperature of the displacing member is higher than the predetermined temperature (at high temperature), the contact part is in contact with the discharge tube. Thus, heat of the discharge tube is radiated toward the heat radiating mechanism via the contact part. Thus, the temperature of the contact point of the discharge tube and the contact part lowers, resulting that the coolest point exists in the vicinity of the contact point and rise of the temperature at the coolest point is suppressed.

The predetermined temperature can be freely set. When the temperature at the coolest point of the discharge tube is a specific temperature, the brightness is the highest. The temperature at the coolest point is proportional to the ambient temperature of the discharge tube during lighting of the discharge tube. Specifically, the brightness of the discharge tube is the highest at the specific ambient temperature (hereinafter referred to as an optimum ambient temperature), and lowers at the temperature that is lower or higher than the optimum ambient temperature. In consideration of the above-mentioned situation, for example, it is possible to set the predetermined temperature on the basis of the optimum ambient temperature. By setting the predetermined temperature in this manner, since the contact part is not in contact with the discharge tube when the ambient temperature is lower than the optimum ambient temperature, temperature rise of the discharge tube (at the coolest point) is not prevented. When the ambient temperature is higher than the optimum ambient temperature, the contact part comes in contact with the discharge tube. Thereby, temperature rise of the discharge tube (at the coolest point) is suppressed. Thus, it can be suppressed that that the temperature of the discharge tube further increases from the state where the brightness of the discharge tube is the highest (the state at the optimum ambient temperature), thereby lowering the brightness. Specifically, the brightness of the discharge tube can be kept high by switching between contact and non-contact of the heat radiating member according to temperature.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device provided in the television receiver in FIG. 1;

FIG. 3 is a sectional view showing a sectional configuration along the short-side direction of the liquid crystal display device in FIG. 2;

FIG. 4 is a sectional view showing a sectional configuration along the long-side direction of the liquid crystal display device in FIG. 2;

FIG. 5 is a sectional view showing a configuration of a heat radiating mechanism in FIG. 3 (non-contact position);

FIG. 6 is a sectional view showing a configuration of the heat radiating mechanism in FIG. 3 (contact position);

FIG. 7 is a graph showing a relationship between brightness of a hot cathode tube and ambient temperature;

FIG. 8 is a sectional view showing a configuration of a heat radiating mechanism according to a second embodiment of the present invention (non-contact position);

FIG. 9 is a sectional view showing a configuration of the heat radiating mechanism according to a second embodiment of the present invention (contact position);

FIG. 10 is a sectional view showing a configuration of a heat radiating mechanism according to a third embodiment of the present invention (non-contact position);

FIG. 11 is a sectional view showing a configuration of a heat radiating mechanism according to a fourth embodiment of the present invention (non-contact position);

FIG. 12 is a sectional view showing a configuration of the heat radiating mechanism according to the fourth embodiment of the present invention (contact position); and

FIG. 13 is a sectional view showing a configuration of the heat radiating mechanism arranged at the both longitudinal ends of a discharge tube.

### BEST MODE FOR CARRYING OUT THE INVENTION

### First Embodiment

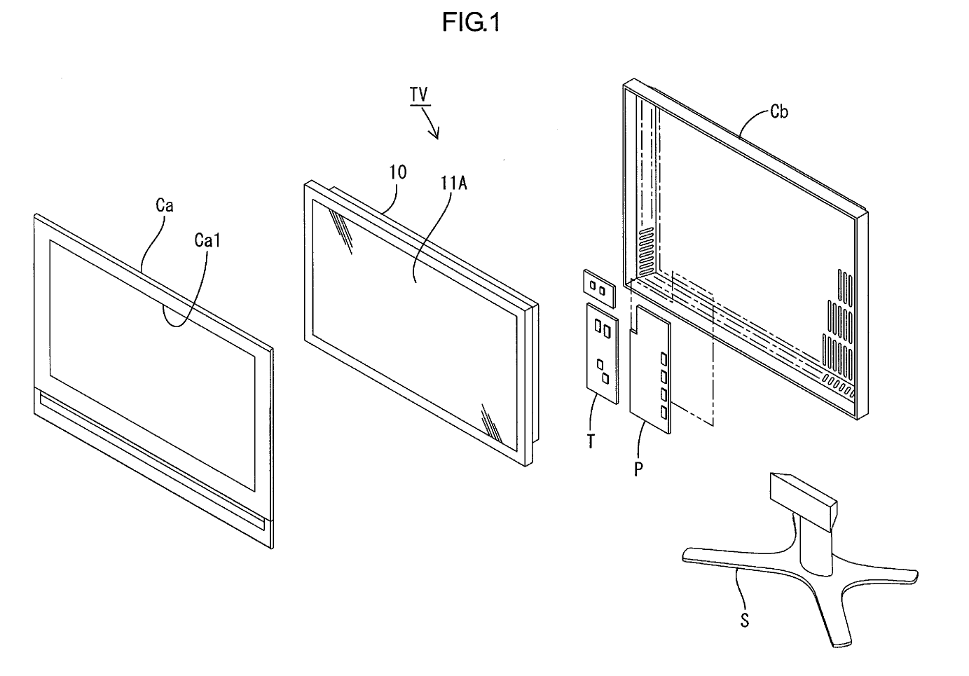

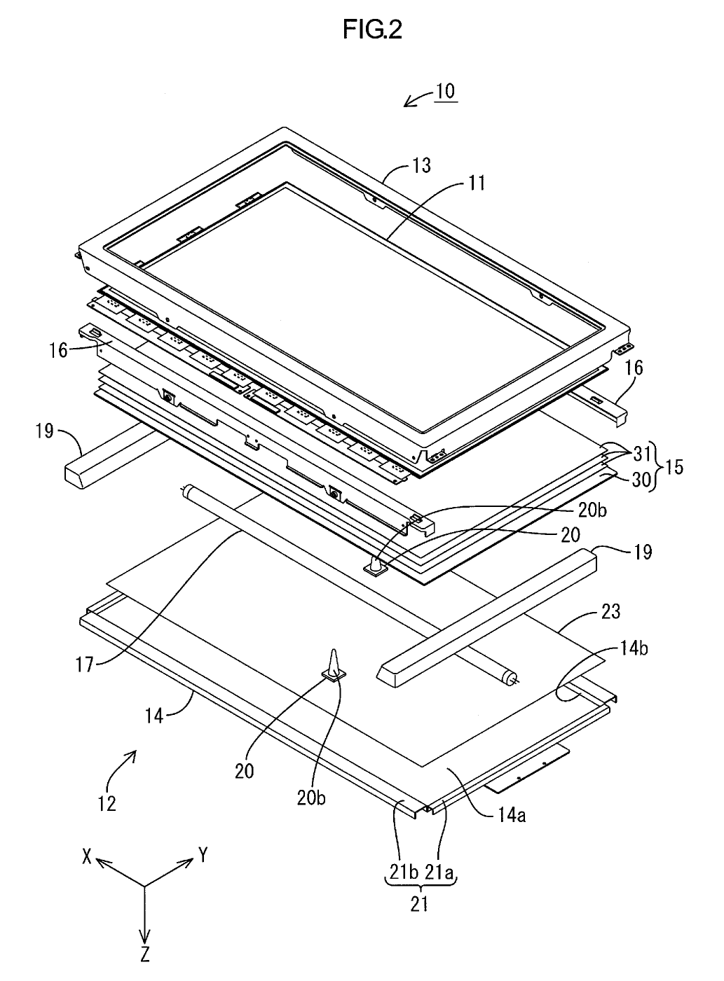

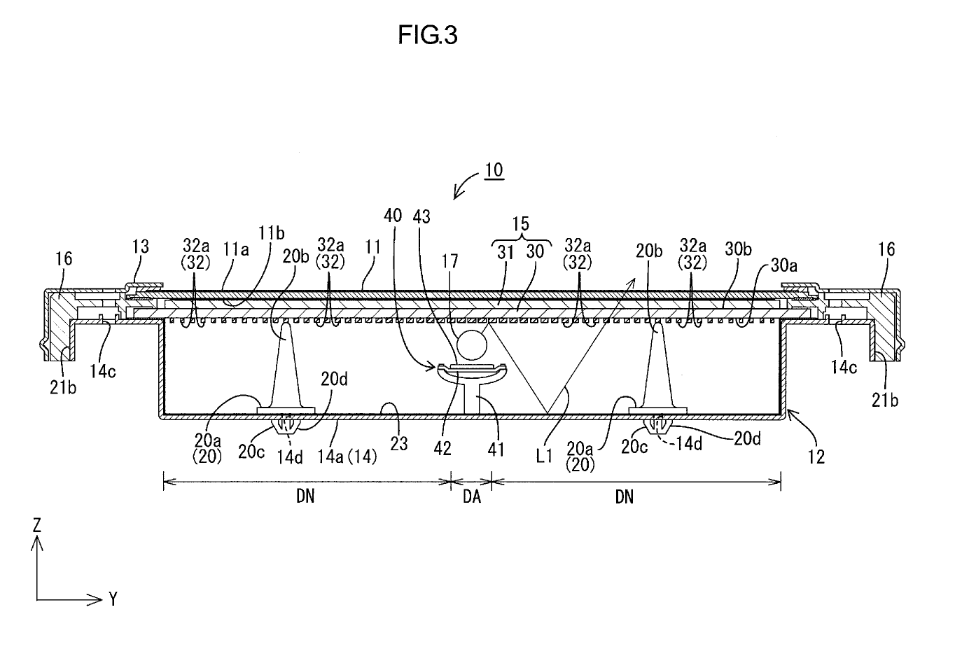

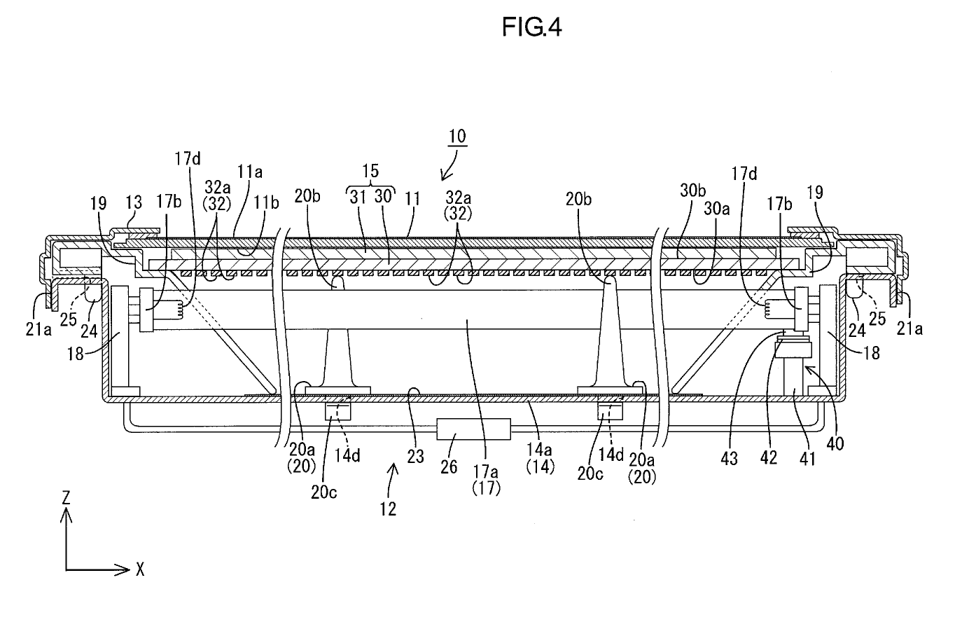

A first embodiment of the present invention will be described with reference to FIGS. 1 to 7. First, configuration of a television receiver TV provided with a liquid crystal display device 10 will be described. FIG. 3 is an exploded perspective view showing a schematic configuration of the television receiver TV according to this embodiment, FIG. 2 is an exploded perspective view showing a schematic configuration of liquid crystal display device provided in the television receiver in FIG. 1, FIG. 3 is a sectional view showing a sectional configuration along the short-side direction of the liquid crystal display device in FIG. 2, and FIG. 4 is a sectional view showing a sectional configuration along the long-side direction of the liquid crystal display device in FIG. 2. The long-side direction of the chassis is defined as an X-axis direction and the short-side direction is defined as the Y-axis direction.

A television receiver TV according to this embodiment includes, as shown in FIG. 1, the liquid crystal display device 10, front and back cabinets Ca and Cb that store the liquid crystal display device 10 therebetween, a power source P, a tuner T and a stand S. The cabinet Ca has an opening Ca1 through which a display surface 11A of a liquid crystal panel 11 is exposed. The liquid crystal display device 10 (display device) is a horizontally long quadrangle (rectangular) and is stored in a vertical orientation. As shown in FIG. 2, the liquid crystal display device 10 includes a backlight unit 12 (lighting device) as an external light source and a liquid crystal panel 11 (display panel) performing display by use of light from the backlight unit 12, and these components are integrally held with a frame-like bezel 13 and the like. The cabinet Ca (frame part) has the opening Ca1 through which the display surface 11A of a liquid crystal panel 11 is exposed.

Next, the liquid crystal panel 11 and the backlight unit 12 constituting the liquid crystal display device 10 will be described. The liquid crystal panel 11 (display panel) is configured by sticking a pair of glass substrates to each other with a predetermined gap therebetween and filling liquid crystal between both the glass substrates. One glass substrate includes switching elements (for example, TFTs) connected to a source wiring and a gate wiring, which are orthogonal to each other, pixel electrodes connected to the switching elements, an alignment film and the like. The other glass substrate includes a color filter in which coloring parts such as R (red), G (green) and B (blue) are arranged in a predetermined pattern, counter electrodes, an alignment film and the like. As shown in FIG. 3, polarizing plates 11a and 11b are arranged on the outer side of each board.

As shown in FIG. 2, the backlight unit 12 includes a substantially box-like chassis 14 having an opening 14b on the side of a light emitting surface (side of the liquid crystal panel 11), an optical member group 15 (diffuser plate 30 and a plurality of optical sheets 31 arranged between the diffuser plate 30 and the liquid crystal panel 11) arranged so as to cover the opening 14b of the chassis 14, and a frame 16 that is arranged along the long side of the chassis 14 and sandwiches the long-side edge of the diffuser plate 30 between the frame 16 and the chassis 14 to hold the long-side edge.

The chassis 14 includes a hot cathode tube 17 (discharge tube) as a light source, a socket 18 serving relay of electrical connection at each end of the hot cathode tube 17, a holder 19 covering the end of the hot cathode tube 17 and the socket 18 and a heat radiating mechanism 40 radiating heat of the hot cathode tube 17. As shown in FIGS. 3 and 4, one hot cathode tube 17 is arranged at the center of the chassis 14 in the short-side direction such that its longitudinal direction (axial direction) matches the long-side direction of the chassis 14. The chassis 14 further has a support pin 20 supporting the optical member 15 from the back side (the hot cathode tube 17 side). In the backlight unit 12, the optical member 15 side relative to the hot cathode tube 17 corresponds to the light emitting side.

The chassis 14 is made of metal and as shown in FIGS. 3 and 4, is shaped like a shallow box-like sheet metal including a rectangular bottom plate 14a in a plan view and a folded outer edge 21 that rises from each side of the bottom plate 14a and is folded back in a substantially U-like fashion (a folded outer edge 21a in the short-side direction and a folded outer edge 21b in the long-side direction). An insertion hole to which the socket 18 is inserted is formed in each end of the bottom plate 14a of the chassis 14 in the long-side direction. As shown in FIG. 3, a fixing hole 14c is formed in an upper surface of the folded outer edge 21b of the chassis 14. The bezel 13, the frame 16 and the chassis 14 can be unified by means of screws, for example.

As shown in FIGS. 3 and 4, the hot cathode tube 17 is tubular (linear) as a whole and includes a hollow glass tube 17a, a pair of ferrules 17b (electrically connecting part) arranged at both ends of the glass tube 17a in the long-side direction, and filaments 17d arranged at both axial ends of the glass tube 17a. The outer diameter of the hot cathode tube 17 (glass tube 17a) is generally larger than the outer diameter of the cold cathode tube (for example, about 4 mm) and is set to, for example, about 15.5 mm.

The glass tube 17a is substantially cylindrical and a fluorescent material is applied to the inner wall surface of the glass tube 17a. The socket 18 is attached to each ferrule 17b of the hot cathode tube 17, and the filaments 17d are electrically connected to an inverter board 26 (power source) attached to the outer surface (back surface) of the bottom plate 14a of the chassis 14 via the socket 18. Specifically, the ferrules 17b serve electrical connection between the filaments 17d and the inverter board 26. The inverter board 26 feeds driving power to the hot cathode tube 17 as well as controls a current value, that is, brightness (lighting state) of the hot cathode tube 17.

The holder 19 covering each end of the hot cathode tube 17 is made of white synthetic resin and as shown in FIG. 2, is shaped like an oblong box extending in the short-side direction of the chassis 14. As shown in FIG. 4, the holder 19 has a step-like front surface on which the optical member 15 or the liquid crystal panel 11 can be mounted at different levels, partially overlaps with the folded outer edge 21a in the short-side direction of the chassis 14 in a plan view, and constitute the side wall of the backlight unit 12 together with the folded outer edge 21a. An insertion pin 24 is protrudingly formed in the surface of the holder 19, which faces the folded outer edge 21a of the chassis 14. By inserting the insertion pin 24 into an insertion hole 25 formed in the upper surface of the folded outer edge 21a of the chassis 14, the holder 19 is attached to the chassis 14.

A reflection sheet 23 is arranged on the inner surface of the bottom plate 14a of the chassis 14 (the surface of the bottom plate 14a facing the hot cathode tube 17). The reflection sheet 23 is made of synthetic resin, has a white surface having a high light reflectivity and is arranged so as to cover almost the entire inner surface of the bottom plate 14a of the chassis 14. As shown in FIG. 3, the long-side edge of the reflection sheet 23 rises so as to cover the folded outer edge 21b of the chassis 14 and is sandwiched between the chassis 14 and the optical member 15. The reflection sheet 23 can reflect light emitted from the hot cathode tube 17 toward the optical member 15.

As shown in FIG. 4, like the liquid crystal panel 11 and the chassis 14, the optical member 15 is rectangular in a plan view. The optical member 15 is interposed between the liquid crystal panel 11 and the hot cathode tube 17, and is constituted of the diffuser plate 30 arranged on the backside (side of the hot cathode tube 17, the side opposite to the light emitting side) and the optical sheets 31 arranged on the front side (side of the liquid crystal panel 11, light emitting side). The diffuser plate 30 is formed by dispersing a lot of diffusing particles in a substantially transparent resin base material having a predetermined thickness, and has a diffusing function of diffusing transmitted light and a reflecting function of reflecting light emitted from the hot cathode tube 17. The optical sheet 31 is shaped like a sheet that is thinner than the diffuser plate 30, and is formed by laminating a diffuser sheet, a lens sheet and a reflection type polarizing sheet in this order from the diffuser plate 30 side.

The support pin 20 supports the diffuser plate 30 from the back side, is made of synthetic resin (for example, polycarbonate) and has a surface of white color having a high light reflectivity. As shown in FIGS. 2 to 4, the support pin 20 is configured of a plate-like body part 20a extending along the bottom plate 14a of the chassis 14, a support part 20b protruding from the body part 20a toward the front side (optical member 15) and a locking part 20c protruding from the body part 20a toward the back side (the bottom plate 14a of the chassis 14).

The locking part 20c has a pair of elastic locking pieces 20d. The both elastic locking pieces 20d are inserted into an attachment hole 14d formed in the chassis 14 and then, are locked at the edge of the attachment hole 14d on the back side, thereby holding the support pin 20 against the chassis 14. The support part 20b is conical as a whole, and has a length such that its rounded front end can come in contact with (or come close to) the back side surface of the diffuser plate 30. Thus, when the diffuser plate 30 is bent or warped, the support part 20b can support the diffuser plate 30 from the back side to suppress bending or warping of the diffuser plate 30.

The diffuser plate 30 is formed by dispersing a predetermined amount of diffusing particle diffusing light in a base material made of almost transparent synthetic resin (for example, polystyrene), and has almost uniform light transmittance and light reflectivity throughout the plate. In the base material of the diffuser plate 30 (except for a below-mentioned light reflecting part 32), it is preferred that the light transmittance is about 70% and the light reflectivity is about 30%. The diffuser plate 30 has a surface facing the hot cathode tube 17 (hereinafter referred to as a first surface 30a) and a surface that is located on the opposite side to the first surface 30a and faces the liquid crystal panel 11 (hereinafter referred to as a second surface 30b). The first surface 30a is a light receiving surface receiving light from the hot cathode tube 17, while the second surface 30b is a light emitting surface emitting light toward the liquid crystal panel 11.

The light reflecting part 32 forming a white dot pattern is formed on the first surface 30a constituting the light receiving surface of the diffuser plate 30. The light reflecting part 32 is configured by arranging a plurality of round dots 32a in a zigzag (staggered, alternate) manner in a plan view. The dot pattern constituting the light reflecting part 32 is formed by printing a paste containing, for example, metal oxide, on the surface of the diffuser plate 30. Screen printing and ink jet printing are preferable as printing means.

The light reflectivity of the light reflecting part 32 is set to, for example, about 75%, which is higher than the light reflectivity of the diffuser plate 30 of about 30%. The average light reflectivity of each material in this embodiment is the average light reflectivity within a diameter measured by use of CM-3700d manufactured by Konica Minolta Holdings, Inc. in LAV (measuring diameter of φ25.4 mm). The light reflectivity of the light reflecting part 32 is measured by forming the light reflecting part 32 over the surface of the glass substrate and measuring the formed surface by use of measuring means.

In the diffuser plate 30, the light reflectivity of the first surface 30a of the diffuser plate 30, which faces the hot cathode tube 17, varies along the short-side direction (Y-axis direction) by varying the dot pattern (area of the each dot 32a) of the light reflecting part 32. Specifically, in the first surface 30a of the diffuser plate 30, the light reflectivity of a part that overlaps with the hot cathode tube 17 (hereinafter referred to as a light source overlapping part DA) is higher than the light reflectivity of a part that does not overlap with the hot cathode tube 17 (hereinafter referred to as a light source non-overlapping part DN). The light reflectivity of the first surface 30a of the diffuser plate 30 hardly varies along the long-side direction and is substantially constant. To achieve such distribution of the light reflectivity, the area of each dot 32a constituting the light reflecting part 32 is set so as to be maximum at the center of the diffuser plate 30 in the short-side direction, that is, the part facing the hot cathode tube 17, and gradually decrease as it moves away therefrom and become minimum at the end of the diffuser plate 30 in the short-side direction. Specifically, the area of each dot 32a is set to be smaller as the distance between the dot 32a and the hot cathode tube 17 is larger.

According to the diffuser plate 30 with such configuration, light emitted from the hot cathode tube 17 directly enters the first surface 30a of the diffuser plate 30, or indirectly enters the first surface 30a of the diffuser plate 30 after being reflected on the reflection sheet 23, the holder 19 or the support pin 20. Then, the light passes through the diffuser plate 30 and then, is exited to the liquid crystal panel 11 via the optical sheets 31. In the first surface 30a of the diffuser plate 30which light emitted from the hot cathode tube 17 enters, the light source overlapping part DA that overlaps with the hot cathode tube 17 receives a large amount of direct light from the hot cathode tube 17, and has a larger amount of light than the light source non-overlapping part DN. Thus, by making the light reflectivity in the light source overlapping part DA of the light reflecting part 32 relatively high, incidence of light on the first surface 30a is suppressed and a large amount of light is reflected and returned into the chassis 14.

On the contrary, in the first surface 30a, the light source non-overlapping part DN that does not overlap with the hot cathode tube 17 receives less direct light from the hot cathode tube 17, and has a smaller amount of light than the light source overlapping part DA. Thus, by making the light reflectivity in the light source non-overlapping part DN of the light reflecting part 32 relatively low, incidence of light on the first surface 30a can be promoted. At this time, since light reflected into the chassis 14 by the light reflecting part 32 in the light source overlapping part DA is guided to the light source non-overlapping part DN by the reflection sheet 23 and the like (beam L1 in FIG. 3) to compensate the amount of light, the amount of light incident on the light source non-overlapping part DN can be sufficiently ensured.

By varying the reflectivity of the diffuser plate 30 in the short-side direction as described above, the distribution of brightness of the illumination light can be made gentle throughout the diffuser plate 30 while arranging the hot cathode tube 17 only at the center in the short-side direction. As a result, gentle brightness distribution throughout the backlight unit 12 can be achieved. As a means of adjusting the light reflectivity, the area of each dot 32a of the light reflecting part 32 may be set uniform and the interval between the dots 32a may be changed.

The heat radiating mechanism 40 is in contact with the hot cathode tube 17, thereby radiating heat of the hot cathode tube 17 toward the chassis 14. The heat radiating mechanism 40 includes a support part 41 attached to the bottom plate 14a of the chassis 14, a displacing part 42 (displacing means) supported by the support part 41, and a heat radiating sheet 43 (contact part) supported by the displacing part 42. As shown in FIG. 3, the heat radiating mechanism 40 is arranged immediately below the hot cathode tube 17 (that is, the center of the chassis in the short-side direction). As shown in FIG. 4, the heat radiating mechanism 40 is arranged at one end of the hot cathode tube 17 in the longitudinal direction, and the heat radiating sheet 43 (described later) as a constituent of the heat radiating mechanism 40 can contact with both the end of the glass tube 17a and the ferrule 17b.

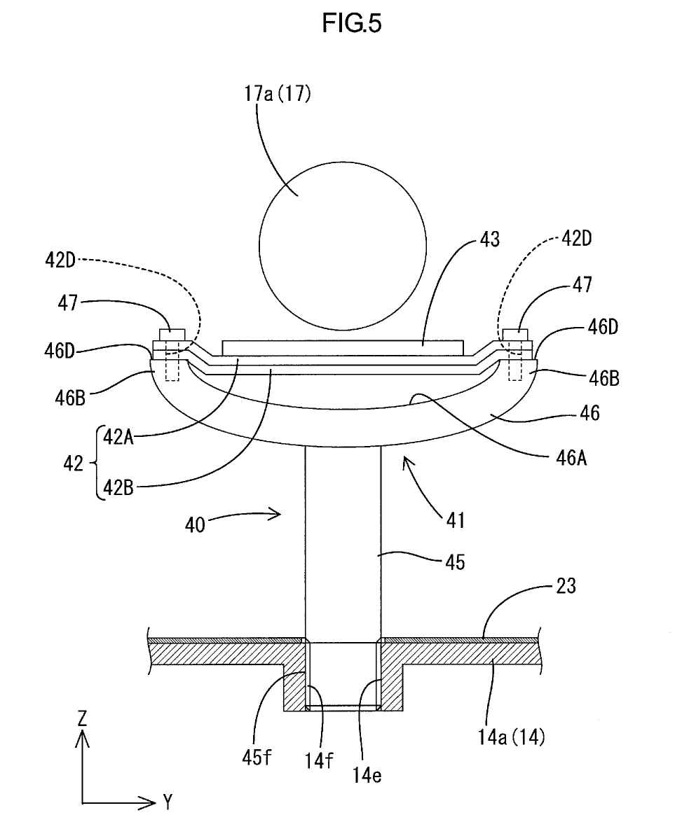

Next, each constituent of the heat radiating mechanism 40 will be described in detail. As shown in FIG. 5, the support part 41 is configured of a strut part 45 and a receiving pan 46 supported by the strut part 45. Preferable materials for the support part 41 are, for example, metal having a high thermal conductivity such as stainless (SUS) and brass. An insertion hole 14e through which the strut part 45 is inserted is formed in the bottom plate 14a of the chassis 14. A male screw 45f is formed on the outer circumferential surface at the lower end (back side) of the strut part 45. A female screw 14f is formed on the inner circumferential surface of the insertion hole 14e. By screwing the screws 14f and 45f together, the strut part 45 can be fixed to the bottom plate 14a of the chassis 14.

The receiving pan 46 is formed at the upper end (front side) of the strut part 45 so as to be integral with the strut part 45, and has a substantially U-like shape or a bifurcated shape and has two ends on the front-surface side. Specifically, the front side surface of the receiving pan 46 is recessed toward the back side and constitutes a displacement allowing part 46A allowing displacement of the displacing part 42 (described later). The displacing part 42 is arranged over both front ends 46B of the bifurcated receiving pan 46. In other words, ends of the displacing part 42 are supported by surfaces 46D of the both front ends 46B of the receiving pan 46, respectively.

The displacing part 42 is configured by stacking and bonding a plate-like shape-memory alloy spring 42A and a plate-like bias spring 42B together. In this embodiment, the shape-memory alloy spring 42A is arranged on the front side (upper side in FIG. 5) and the bias spring 42B is arranged on the back side (upper side in FIG. 5). The heat radiating sheet 43 is arranged on the front side surface of the shape-memory alloy spring 42A. Examples of the method of bonding the shape-memory alloy spring 42A to the bias spring 42B include a bonding method of caulking the both springs 42A and 42B by use of a rivet or the like (mechanical bonding) and a bonding method of heating the both springs 42A and 42B with their bonding surfaces being in contact with each other to melt boding points and then, compressing the springs with high pressure.

Both ends of the displacing part 42 in the Y-axis direction are fixed to the both front ends 46B of the receiving pan 46 with screws 47, respectively. Specifically, each screw 47 passes through both the shape-memory alloy spring 42A and the bias spring 42B (via a through hole 42D), and a front end of each screw 47 is attached to each front end 46B of the receiving pan 46. The diameter of the through hole 42D is slightly larger than the diameter of the screw 47, and the displacing part 42 can slightly move in the Y-axis direction with the screw 47 passing therethrough. For this reason, the center of the displacing part 42 in the Y-axis direction (except for both ends) can be displaced in the Z-axis direction.

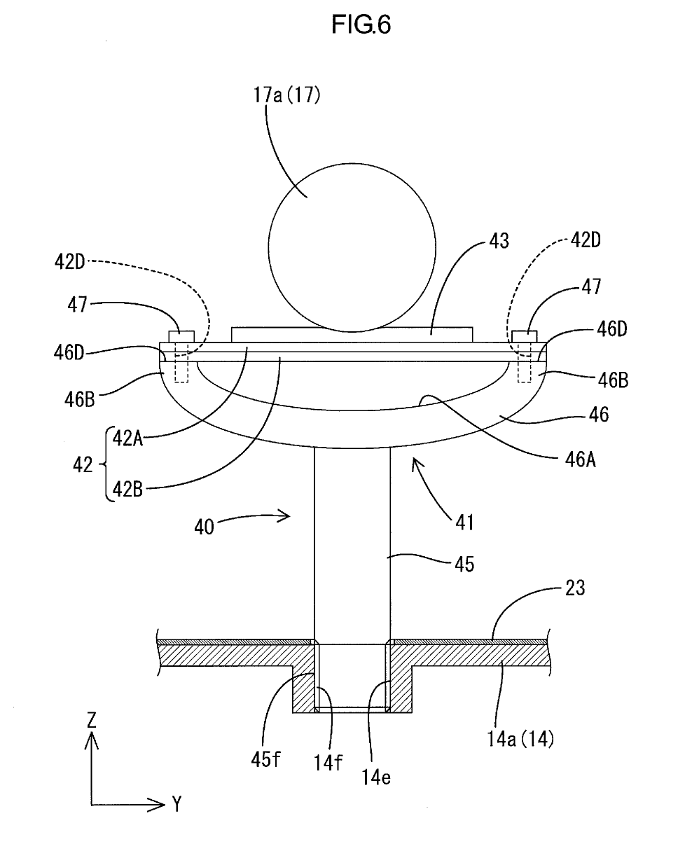

The displacing part 42 has a function to displace the heat radiating sheet 43 between a non-contact position and a contact position according to the temperature of the shape-memory alloy spring 42A. The non-contact position is the position where the heat radiating sheet 43 is not in contact with the hot cathode tube 17 (glass tube 17a) (position shown in FIG. 5), and the contact position is the position where the heat radiating sheet 43 is in contact with the back side of the hot cathode tube 17 (both the glass tube 17a and the ferrules 17b) (position shown in FIG. 6). In other words, the support part 41 displaceably supports the heat radiating sheet 43 via the displacing part 42.

The configuration of the displacing part 42 will be described in more detail. The shape-memory alloy spring 42A is made of shape-memory alloy such as Ni−Ti and Cu—Zn—Al. When the temperature of the shape-memory alloy spring 42A becomes higher than the transformation temperature, the shape-memory alloy spring 42A restores the flat plate shape shown in FIG. 6 (previously stored shape). The bias spring 42B biases the heat radiating sheet 43 toward the non-contact position (the direction away from the hot cathode tube 17, back side), and is made of SUS steel, spring steel or the like. The bias spring 42B is recessed toward the back side as shown in FIG. 5 in the natural state. In this embodiment, the transformation temperature is an example of “predetermined temperature”.

When the temperature of the shape-memory alloy spring 42A is lower than the transformation temperature, the biasing force of the bias spring 42B toward the back side (force by which the center of the bias spring 42B is recessed toward the back side as shown in FIG. 5) is set to be larger than the biasing force of the shape-memory alloy spring 42A toward the front side (force by which the shape-memory alloy spring 42A is made flat as shown in FIG. 6). For this reason, the displacing part 42 is recessed toward the back side as shown in FIG. 5 and the heat radiating sheet 43 is located at the non-contact position.

At a temperature that is higher than the transformation temperature, the shape-memory alloy spring 42A attempts to return to the flat plate shape (state shown in FIG. 6), the biasing force (restoring force) of the shape-memory alloy spring 42A toward the front side at this time is set to be larger than the biasing force of the bias spring 42B toward the back side. For this reason, when the temperature of the shape-memory alloy spring 42A is higher than the transformation temperature, the shape-memory alloy spring 42A displaces the heat radiating sheet 43 to the contact position against the biasing force of the bias spring 42B toward the back side.

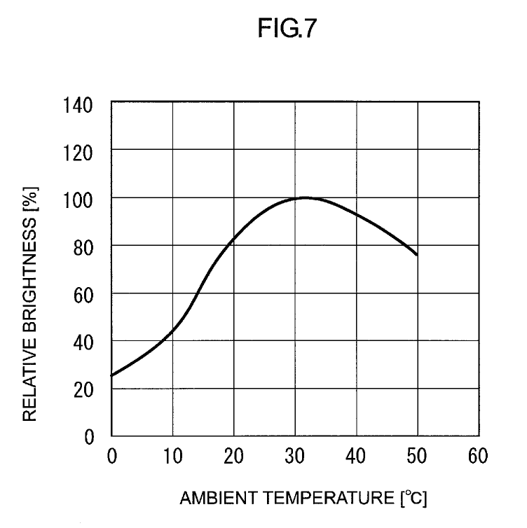

The transformation temperature of the shape-memory alloy spring 42A is set based on temperature at which the brightness of the hot cathode tube 17 becomes the highest (described later in detail). To explain this, first, relationship between the hot cathode tube and temperature will be described with reference to FIG. 7. FIG. 7 is a graph showing the relationship between the ambient temperature and brightness of the hot cathode tube 17. As shown in FIG. 7, the brightness of the hot cathode tube 17 varies depending on the ambient temperature, and becomes the highest at the specific ambient temperature (about 32° C. in FIG. 7, hereinafter referred to as optimum ambient temperature). This is because the point where the temperature of the glass tube 17a becomes the lowest (coolest point) changes with a change in the ambient temperature, resulting that the vapor pressure of mercury filled in the tube changes to change the light emitting efficiency. Specifically, when the temperature at the coolest point rises and the mercury vapor pressure rises, the amount of ultraviolet light emitted from mercury increases, thereby improving the light emitting efficiency. When the temperature at the coolest point further rises and the mercury vapor pressure further rises, the amount of ultraviolet light absorbed by surrounding mercury from the ultraviolet light discharged from mercury increases. Then, the amount of ultraviolet light striking the fluorescent material decreases, thereby lowering the light emitting efficiency, and this lowers the brightness.

In other words, in order to use the hot cathode tube 17 with highest brightness, it is undesired that the temperature at the coolest point is too high or too low and therefore, the temperature needs to be maintained at the coolest point of the hot cathode tube 17 in the case where the ambient temperature is the optimum ambient temperature (for example, 32° C.). For this reason, in this embodiment, the temperature of the shape-memory alloy spring 42A at the ambient temperature of 32° C. is set as the transformation temperature of the shape-memory alloy spring 42A. In other words, the transformation temperature of the shape-memory alloy spring 42A is set based on the ambient temperature of the hot cathode tube 17 (in turn, the temperature at the coolest point). As a matter of course, the optimum ambient temperature of the hot cathode tube 17 varies depending on specifications and installation environment of the hot cathode tube 17 and is not limited to 32° C.

The heat radiating sheet 43 is rectangular in a plan view and has a high heat conductivity. The heat radiating sheet 43 is the elastically deformable elastic member. Examples of such heat radiating sheet 43 include a trade name “hypersoft heat radiating material” manufactured by Sumitomo 3M Limited. The back side surface of the heat radiating sheet 43 is adhered to the front side surface of the shape-memory alloy spring 42A.

With the above-mentioned configuration, heat of the heat radiating sheet 43 is radiated toward the chassis 14 via the displacing part 42 and the support part 41. In other words, the heat radiating sheet 43, the displacing part 42, the support part 41 and the chassis 14 are thermally connected. To promote heat radiation between the members, it is preferable to apply grease having a high heat conductivity to the contact point of each member (for example, the contact point between the displacing part 42 and the support part 41).

Next, operations and effects at the time when the hot cathode tube 17 of the backlight unit 12 in this embodiment is lighted will be described. In the state prior to lighting of the hot cathode tube 17, it is assumed that the temperature of the shape-memory alloy spring 42A is the transformation temperature or lower and the heat radiating sheet 43 is located at the non-contact position. First, when driving power is supplied from the inverter board 26 to the hot cathode tube 17, electricity is discharged from the filaments 17d of the hot cathode tube 17. Thereby, in the glass tube 17a, electrons hit against filled mercury, resulting that mercury is excited to emit ultraviolet light. The ultraviolet light excites the fluorescent material applied to the inner wall surface of the glass tube 17a and visible light is generated.

As described above, when the hot cathode tube 17 is lit, the temperature of the inside of the glass tube 17a and the ambient temperature of the hot cathode tube 17 rises due to heat generation during electrification (mainly from the filaments 17d). Thus, the temperature of the shape-memory alloy spring 42A also rises. Then, when the ambient temperature of the hot cathode tube 17 exceeds 32° C. and the temperature of the shape-memory alloy spring 42A becomes higher than the transformation temperature, the displacing part 42 becomes flat plate-like as shown in FIG. 6 to displace the heat radiating sheet 43 to the contact position. As a result, the heat radiating sheet 43 is in contact with the hot cathode tube 17. Heat of the contact point of the heat radiating sheet 43 (in the vicinity of the ferrules 17b) is transmitted in the path of the heat radiating sheet 43, the displacing part 42, the support part 41 and the chassis 14 in this order, and is radiated toward the chassis 14. This can suppress temperature rise at the contact point of the heat radiating sheet 43. The contact point of the heat radiating sheet 43 becomes the coolest point (the coolest point in the glass tube 17a). As described above, in this embodiment, when the temperature of the shape-memory alloy spring 42A is higher than the transformation temperature (when the ambient temperature is higher than the optimum ambient temperature), temperature rise at the coolest point in the glass tube 17a can be suppressed, thereby suppressing lowering of the brightness.

When the temperature of the shape-memory alloy spring 42A is lower than the transformation temperature, that is, the ambient temperature of the hot cathode tube 17 is lower than 32° C., the biasing force of the shape-memory alloy spring 42A toward the front side is larger than the biasing force of the bias spring 42B toward the back side. For this reason, the displacing part 42 is recessed toward the back side as shown in FIG. 5 to displace the heat radiating sheet 43 to the non-contact position. At this time, the heat radiating sheet 43 is not in contact with the hot cathode tube 17. Specifically, when the temperature of the shape-memory alloy spring 42A is lower than the transformation temperature (when the ambient temperature is lower than the optimum ambient temperature), the heat radiating mechanism 40 can prevent lowering of the brightness of the hot cathode tube 17 without preventing temperature rise of the hot cathode tube 17.

The support part 41 displaceably supporting the heat radiating sheet 43 via the displacing part 42 may be provided, and the support part 41 may be attached to the chassis 14. With such configuration, heat transmitted from the hot cathode tube 17 to the heat radiating sheet 43 is radiated toward the chassis 14 via the displacing part 42 and the support part 41. This can suppress temperature rise at the coolest point more effectively.

The support part 41 is made of metal. The metal support part 41 improves the heat conductivity and further promotes heat radiation to the chassis 14.

The displacing part 42 includes the bias spring 42B that biases the heat radiating sheet 43 toward the non-contact position, and the shape-memory alloy spring 42A that restores the previously stored shape at a temperature that is higher than the transformation temperature (predetermined temperature) to displace the heat radiating sheet 43 to the contact position against the biasing force of the bias spring 42B. With such configuration, the heat radiating sheet 43 can be put into contact with the hot cathode tube 17 at a temperature that is lower than the transformation temperature, and can be put into contact with the hot cathode tube 17 at a temperature that is higher than the transformation temperature.

The both shape-memory alloy spring 42A and the bias spring 42B are plate-like and overlap with each other to constitute the displacing part 42. With such configuration, as compared to configuration in which the shape-memory alloy spring 42A and the bias spring 42B are, for example, coil springs, the thickness of the displacing part 42 can be reduced.

The inverter board 26 supplying driving power to the hot cathode tube 17 is provided. The hot cathode tube 17 has ferrule 17b serving electrical connection with the inverter board 26, and the heat radiating sheet 43 is in contact with the ferrule 17b. With such configuration, by lowering the temperature of the ferrules 17b, the vicinity of the ferrules 17b can become the coolest point.

The heat radiating sheet 43 may be formed of an elastic member. With such configuration, when the heat radiating sheet 43 is in contact with the hot cathode tube 17, the adhesion properties are improved and therefore, heat can be radiated more effectively.

The hot cathode tube 17 is used as the discharge tube. The brightness of the hot cathode tube 17 is more susceptible to the ambient temperature than that of other discharge tubes (for example, cold cathode tube). For this reason, as in this embodiment, the configuration using the hot cathode tube is effective.

### Second Embodiment

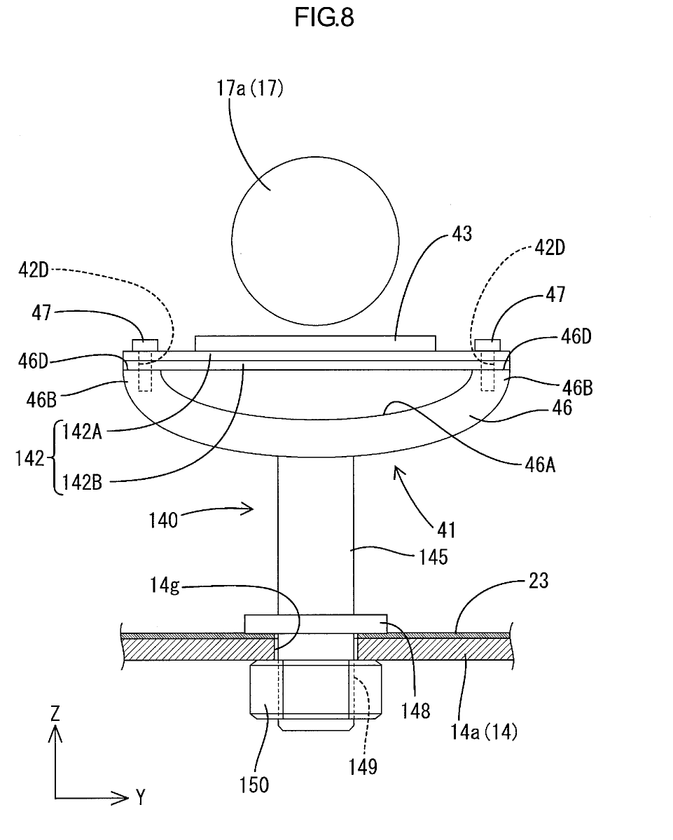

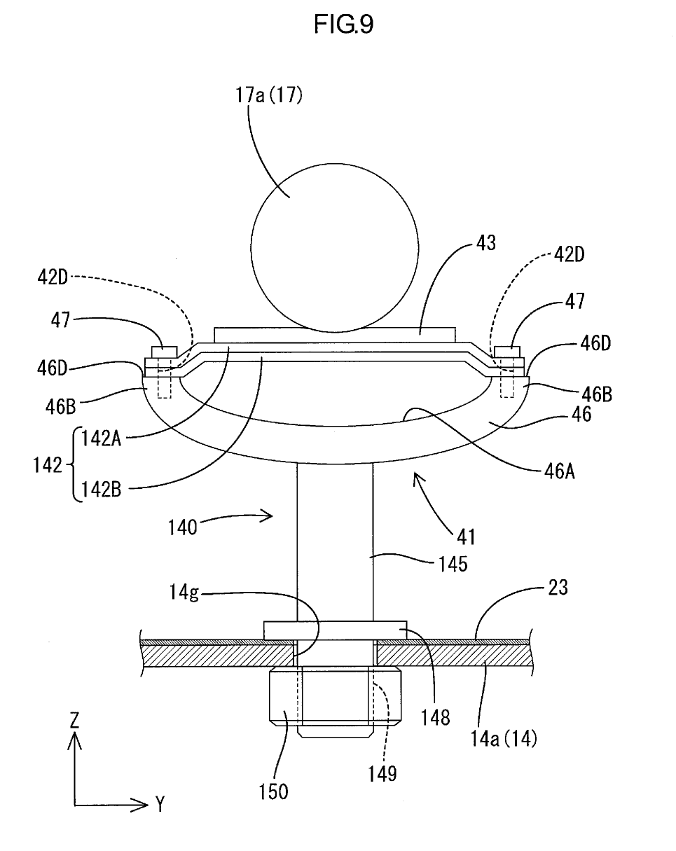

A second embodiment of the present invention will be described with reference to FIGS. 8 and 9. This embodiment is different from the first embodiment in configuration of a heat radiating mechanism 140. The same parts as those in each of the first embodiment are given the same reference numerals and will not be explained. In the heat radiating mechanism 140 in this embodiment, a displacing part 142 is configured of bimetal formed by bonding two metal plates 142A and 142B having different coefficients of thermal expansion to each other.

The coefficient of thermal expansion of the metal plate 142A is set to be higher than that of the metal plate 142B. Thus, at a temperature that is lower than the predetermined temperature, the displacing part 142 is flat plate-like and the heat radiating sheet 43 is located at the non-contact position (state shown in FIG. 8). At a temperature that is higher than the predetermined temperature, the metal plate 142B contracts relative to the metal plate 142A in the Y-axis direction, resulting that the displacing part 142 is deformed so as to be recessed toward the front side. Thereby, the heat radiating sheet 43 is displaced to the contact position (state shown in FIG. 9).

Also in this embodiment, the predetermined temperature can beset as appropriate. However, for example, as in first embodiment, the predetermined temperature may correspond to the ambient temperature in the case where the brightness of the hot cathode tube 17 is the highest. In other words, it may be configured such that, when the ambient temperature rises and becomes higher than the optimum ambient temperature, the displacing part 142 is recessed toward the front side and the heat radiating sheet 43 comes into contact with the hot cathode tube 17. To adjust the temperature at which the displacing part 142 is recessed toward the front side, for example, materials for the metal plate 142A and the metal plate 142B (mainly, coefficient of thermal expansion) are selected or various sizes (thickness, dimension) are adjusted. Since operations and effects during lighting of the hot cathode tube 17 in this embodiment are the same as those in the first embodiment, description thereof is omitted.

This embodiment is different from the above-mentioned embodiments in the attachment structure of the heat radiating mechanism 140 to the chassis 14. A flat plate-like pressing part 148 is provided at a lower end (end on the back side) of a strut part 145 of the heat radiating mechanism 140. A male screw is formed at a position closer to the lower end than the pressing part 148 on the outer circumferential surface of the strut part 145 to constitute a bolt part 149. A nut 150 can be screwed into the bolt part 149 from the back side. With this configuration, the bolt part 149 can be inserted into an insertion hole 14g formed in the bottom plate 14a of the chassis 14 and then, the nut 150 can be screwed into the bolt part 149, thereby fixedly sandwiching the bottom plate 14a between the pressing part 148 and the nut 150 from the back and front directions.

### Third Embodiment

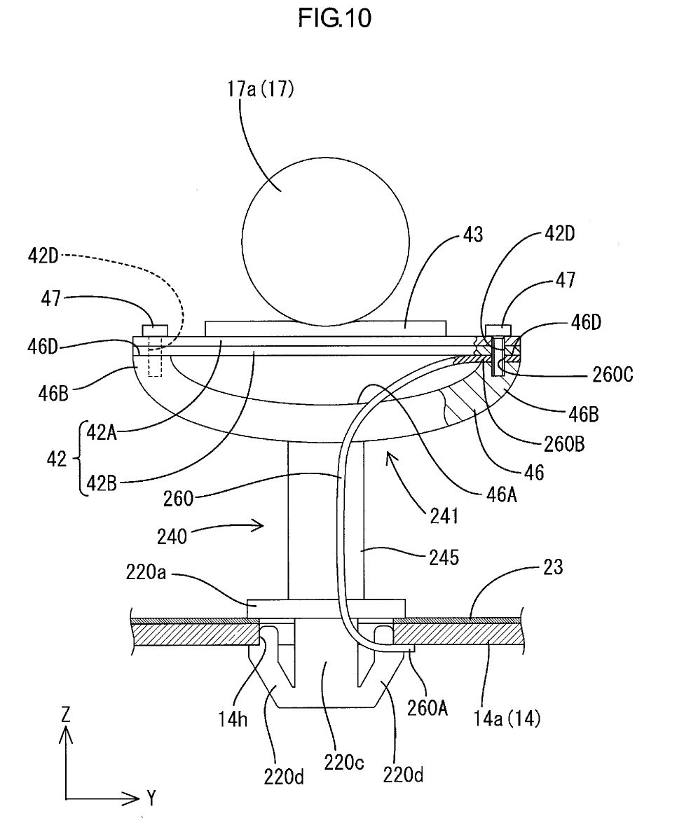

A third embodiment of the present invention will be described with reference to FIG. 10. This embodiment is different from the first embodiment in the configuration of a heat radiating mechanism 240. The same parts as those in each of the above-mentioned embodiments are given the same reference numerals and will not be explained. In the heat radiating mechanism 240 in this embodiment, a support part 241 is made of synthetic resin, and a thermally conductive member 260 thermally connecting the displacing part 42 to the chassis 14 is provided.

The thermally conductive member 260 is, for example, a foil of metal having a high heat conductivity (for example, copper) and is oblong. Most of the thermally conductive member 260 is attached along the support part 241. One end 260B of the thermally conductive member 260 is sandwiched between the surface 46D of the front end 46B of the receiving pan 46 and the lower surface of the displacing part 42. By inserting the screw 47 into a through hole 260C formed in the end 260B, the thermally conductive member 260 is attached to the receiving pan 46. The thermally conductive member 260 passes through an attachment hole 14h formed in the chassis 14. The other end 260A is attached to the back side surface of the bottom plate 14a of the chassis 14. In this manner, the displacing part 42 is thermally connected to the chassis 14 via the thermally conductive member 260.

This embodiment is different from each of the above-mentioned embodiments in the attachment structure of the heat radiating mechanism 240 to the chassis 14. A plate-like body part 220a along the bottom plate 14a of the chassis 14 and a locking part 220c protruding from the body part 220a toward the back side (the bottom plate 14a of the chassis 14) are formed at a lower end (end on the back side) of a strut part 245 of the support part 241. The locking part 220c includes a pair of elastic locking pieces 220d. The both elastic locking pieces 220d are inserted into the attachment hole 14h formed in the chassis 14 while deforming the direction of contracting in the Y-axis direction and then, reaches the back side of the chassis 14 and finally restores elastically, thereby being locked at the edge of the attachment hole 14h on the back side. Thus, both the elastic locking pieces 220d perform a function to hold the strut part 245 while preventing the strut part 245 from escaping from the chassis 14.

As described above, in this embodiment, by providing the thermally conductive member 260 thermally connecting the displacing part 42 to the chassis 14, heat can be radiated from the displacing part 42 to the chassis 14 via the thermally conductive member 260. Thus, although the support part 241 is made of synthetic resin having a relatively low heat conductivity, in the state where the heat radiating sheet 43 is in contact with the hot cathode tube 17, heat of the hot cathode tube 17 can be effectively radiated toward the chassis 14. The support part 241 can be made of a material having a low heat conductivity, improving the freedom of flexibility in design. By making the support part 241 from synthetic resin, in the attachment structure to the chassis 14, the locking structure formed of the elastic locking pieces 220d can be easily adopted. Any thermally conductive member 260 may be used as long as it is a member having a high heat conductivity. For example, a member having a high heat conductivity, such as a thermally conductive tube or a heat pipe, may be used in place of the metal foil.

### Fourth Embodiment

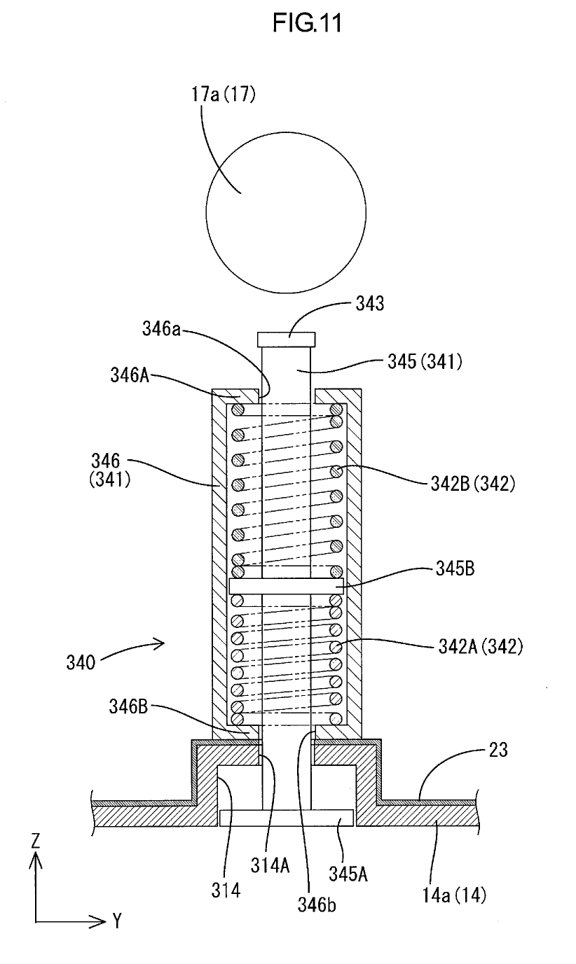

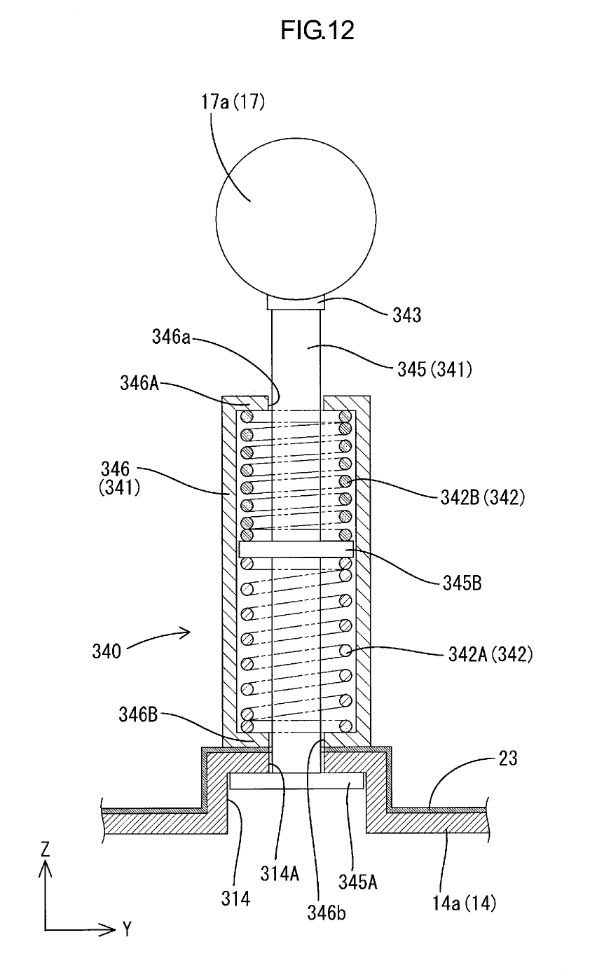

Next, a fourth embodiment of the present invention will be described with reference to FIGS. 11 and 12. This embodiment is different from each of the above-mentioned embodiments in the configuration of a heat radiating mechanism 340. The same parts as those in each of the above-mentioned embodiments are given the same reference numerals and will not be explained. In the heat radiating mechanism 340 in this embodiment, a support part 341 includes a tubular part 346 extending in the front-back directions and an insertion rod 345 inserted into the tubular part 346.

In this embodiment, an attachment concave part 314 is formed by denting a part of the bottom plate 14a of the chassis 14 toward the front side, and the substantially cylindrical tubular part 346 is mounted on the front side of the attachment concave part 314. The tubular part 346 has a through hole 346a passing through an upper wall 346A and a through hole 346b passing through a lower wall 346B. The insertion rod 345 is configured to be inserted into the through hole 346a and the through hole 346b such that the insertion rod 345 can move relative to the tubular part 346 in the back and front directions.

The insertion rod 345 is cylindrical. An upper part of the insertion rod 345 protrudes through the through hole 346a, and a heat radiating sheet 343 is attached to an upper end surface (one end) of the insertion rod 345, for example, by adhesion. A lower part of the insertion rod 345 passes through the through hole 346b and a through hole 314A formed in an attachment convex part 314 and protrudes toward the back side of the chassis 14. The flat plate-like abutting part 345A is provided at a lower end (the other end) of the insertion rod 345. The abutting part 345A has dimension that can be stored in the attachment concave part 314. A flat plate part 345B is attached to the center of the insertion rod 345 in the longitudinal direction (Z-axis direction).

In this embodiment, both of a shape-memory alloy spring 342A and a bias spring 342B constituting a displacing part 342 are coil springs, and are wound around the insertion rod 345 and are stored in the tubular part 346. The both springs 342A and 342B can displace the insertion rod 345 with respect to the tubular part 346 to displace the heat radiating sheet 343. Also in this embodiment, the non-contact position is the position where the heat radiating sheet 343 is not in contact with the hot cathode tube 17 (glass tube 17a) (position shown in FIG. 11), and the contact position is the position where the heat radiating sheet 343 is in contact with the back side of the hot cathode tube 17 (glass tube 17a) (position shown in FIG. 12).

The shape-memory alloy spring 342A is arranged further from the hot cathode tube 17 and the bias spring 342B is arranged closer to the hot cathode tube 17. Specifically, the shape-memory alloy spring 342A is arranged in the compressed state between the flat plate part 345B of the insertion rod 345 and the lower wall 346B (shorter than the natural length), and the bias spring 342B is arranged in the compressed state between the flat plate part 345B of the insertion rod 345 and the upper wall 346A. Thereby, the flat plate part 345B (in turn, heat radiating sheet 343) is biased toward the front side (side close to the hot cathode tube 17) by the shape-memory alloy spring 342A, and toward the back side (side further from the hot cathode tube 17) by the bias spring 342B.

Materials for the shape-memory alloy spring 342A and the bias spring 342B are the same as, for example, the materials of the shape-memory alloy spring 42A and the bias spring 42B in first embodiment. When the temperature of the shape-memory alloy spring 342A is lower than the predetermined temperature (transformation temperature), the heat radiating sheet 43 is located at the non-contact position (state shown in FIG. 11), and the biasing force of the shape-memory alloy spring 342A matches that of the bias spring 342B. In other words, physical property values such as the elastic coefficients of the shape-memory alloy spring 342A and the bias spring 342B are set so as to achieve the above-mentioned configuration.

When the temperature of the shape-memory alloy spring 342A is higher than the transformation temperature, the shape-memory alloy spring 342A returns from the shape at a temperature that is lower than the transformation temperature to the shape with long length (shape shown in FIG. 12). Specifically, when the temperature of the shape-memory alloy spring 342A becomes higher than the transformation temperature, the shape-memory alloy spring 342A is extended. When the temperature of the shape-memory alloy spring 342A becomes higher than the transformation temperature, the shape-memory alloy spring 342A extends against the biasing force of the bias spring 342B to displace the heat radiating sheet 343 to the contact position. In other words, the heat radiating sheet 343 is displaced by a difference between the length of the shape-memory alloy spring 342A in the contracted state shown in FIG. 11 and the length of the shape-memory alloy spring 342A in the extended state shown in FIG. 12. At the contact position in FIG. 12, an abutting part 345A of the insertion rod 345 is in contact with the inner surface (back side surface) of the attachment concave part 314 of the chassis 14. Thereby, at the contact position, the hot cathode tube 17, the heat radiating sheet 343, the insertion rod 345, the abutting part 345A and the chassis 14 are thermally connected in this order.

With the above-mentioned configuration, in this embodiment, as in each of the above-mentioned embodiments, when the ambient temperature of the hot cathode tube 17 rises and the temperature of the shape-memory alloy spring 342A becomes higher than the transformation temperature, the heat radiating sheet 343 comes into contact with the hot cathode tube 17. Thereby, heat of the hot cathode tube 17 is transmitted to the heat radiating sheet 343, the insertion rod 345, the abutting part 345A and the chassis 14 in this order, and is radiated toward the chassis 14. When the temperature of the shape-memory alloy spring 342A becomes lower than the transformation temperature, the heat radiating sheet 343 is not in contact with the hot cathode tube 17. For this reason, at a temperature that is lower than the transformation temperature (when the ambient temperature is lower than the optimum ambient temperature), temperature rise of the hot cathode tube 17 is not hindered. Since the effect obtained by the fact that the heat radiating sheet 343 is or is not in contact with the hot cathode tube 17 according to the ambient temperature is the same as that in first embodiment, detailed description thereof is omitted.

The support part 41 is attached to the chassis 14, and includes the glass tube 17a and the insertion rod 345 inserted into the glass tube 17a. The heat radiating sheet 343 is attached to one end of the insertion rod 345, and the shape-memory alloy spring 342A and the bias spring 342B are each a coil spring and wound around the insertion rod 345, thereby making the insertion rod 345 displaceable with respect to the tubular part. With such configuration, as compared to the case where the shape-memory alloy spring 342A and the bias spring 342B are plate-like, for example, a larger displacement of the displacing part 342 can be ensured.

The abutting part 345A that comes into contact with the chassis 14 when the temperature of the shape-memory alloy spring 342A is higher than the transformation temperature (predetermined temperature) is provided at the other end of the insertion rod 345. With the configuration in which the abutting part 345A comes into contact with the chassis 14 at a temperature that is higher than the predetermined temperature, heat transmitted to the heat radiating sheet 343 can be radiated toward the chassis 14 via the insertion rod 345 and the abutting part and therefore, more effective heat radiation can be achieved.

### Other Embodiments

The present invention is not limited to the embodiments described in the above description and figures, and for example, the following embodiments also fall within the technical scope of the present invention.

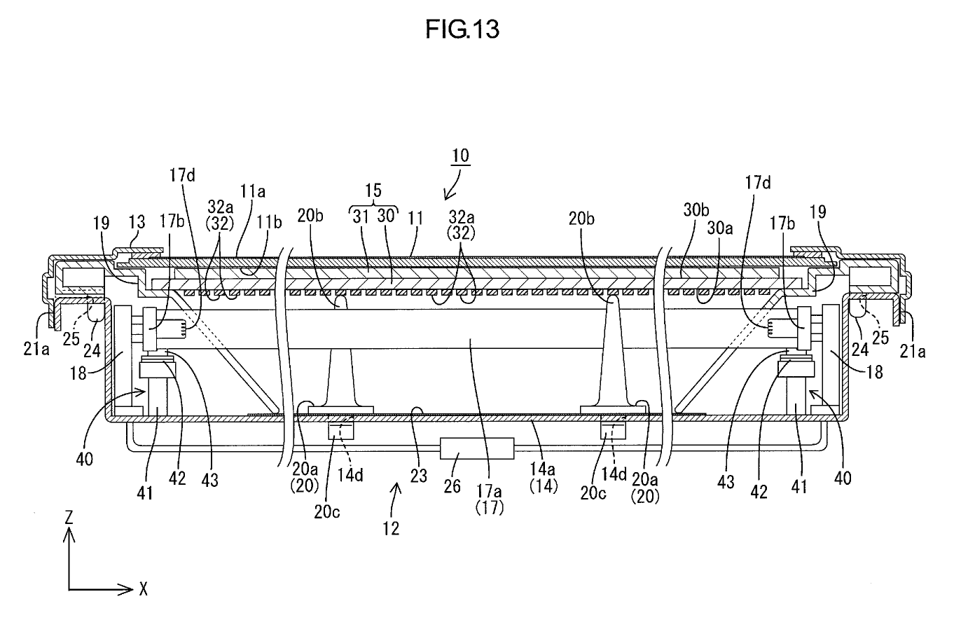

(1) Although the heat radiating mechanism 40 is provided at only one end of the hot cathode tube 17 in the longitudinal direction in first embodiment, the heat radiating mechanism 40 may be provided at each end of the hot cathode tube 17 in the longitudinal direction, as shown in FIG. 13. With such configuration (a plurality of contact points exist), the cooler point of two contact points between the hot cathode tube 17 and the heat radiating mechanisms 40 serves as the coolest point.

(2) The displacing part may be a shape-memory alloy spring having a bidirectional property. The bidirectional property used herein refers to two shapes: a shape at a temperature that is lower than the predetermined temperature and a shape at a temperature that is higher than the predetermined temperature. Such displacing part can be constituted by the shape-memory alloy spring only without using the bias spring. Although the displacing part is made of a material which deforms due to temperature, the displacing part may be configured of a temperature sensor and an actuator that is connected to the temperature sensor and displaces the heat radiating sheet according to the predetermined temperature.

(3) Although the heat radiating sheet is provided over the end of the glass tube 17a and the ferrule 17b in the embodiments, the contact point of the heat radiating sheet is not limited to this. The heat radiating sheet only need to be in contact with a part of the hot cathode tube 17, and for example, may be in contact with only the ferrule 17b.

(4) In first embodiment, as the method of bonding the shape-memory alloy spring 42A to the bias spring 42B, the mechanical bonding method such as caulking and the bonding method of thermally compressing the bonding surfaces are described. However, the boding method is not limited to these.

(5) In each of the above-mentioned embodiments, the temperature at which the displacing part is displaced to the contact position (temperature that is higher than the predetermined temperature, the transformation temperature of the shape-memory alloy spring or the temperature at which the bimetal is deformed) can be varied as appropriate based on the use environment of the hot cathode tube 17 or the like. In other words, the predetermined temperature can freely be set.

(6) In the fourth embodiment, the shape-memory alloy spring 342A is arranged away from the hot cathode tube 17, and the bias spring 342B is arranged close to the hot cathode tube 17. However, conversely, the shape-memory alloy spring 342A may be arranged closer to the hot cathode tube 17, and the bias spring 342B may be arranged away from the hot cathode tube 17. In the case of this configuration, the shape-memory alloy spring 342A may be configured that its length is shortened when the temperature becomes the transformation temperature or higher.

(7) Although the heat radiating sheet is used as the contact part in each embodiment, the contact part is not limited to the heat radiating sheet.

(8) Although the hot cathode tube 17 extends in the long-side direction of the chassis 14 (X-axis direction) in the above-mentioned embodiments, the hot cathode tube 17 may extend in the short-side direction of the chassis 14 (Y-axis direction). A plurality of hot cathode tubes 17 may be provided, and the heat radiating mechanisms 40 may be attached to the hot cathode tubes 17, respectively.

(9) Although the hot cathode tube 17 is used as the discharge tube in the above-mentioned embodiments, other types of discharge tubes (for example, the cold cathode tube) may be used, and the configuration using plural types of discharge tubes also falls within the present invention. For example, the hot cathode tube and the cold cathode tube may be mixed.

(10) Although the liquid crystal panel and the chassis are placed in the vertical position such that the short-side direction matches the vertical direction in the above-mentioned embodiments, the present invention can also be also applied to the liquid crystal panel and the chassis placed in the vertical position such that the long-side direction matches the vertical direction.

(11) Although the TFT is used as the switching element of the liquid crystal display device in the above-mentioned embodiments, the present invention can also be applied to the liquid crystal display device using the switching element instead of the TFT (for example, thin film diode (TFD)) and the color liquid crystal display device as well as the monochrome liquid crystal display device.

(12) Although the liquid crystal display device using the liquid crystal panel as the display panel is described in the above-mentioned embodiments, the present invention can also be applied to the display device using other types of display panels.

(13) Although the television receiver provided with a tuner is described in the above-mentioned embodiments, the present invention can also be applied to the display device with no tuner.

1. A lighting device comprising:
a discharge tube;
a chassis configured to house the discharge tube therein; and
a heat radiating mechanism configured to come in contact with the discharge tube and radiate heat of the discharge tube, the heat radiating mechanism including:
a contact part configured to contact with the discharge tube; and
displacing member configured to displace the contact part between a contact position where the contact part is in contact with the discharge tube and a non-contact position where the contact part is not in contact with the discharge tube, the displacing member displacing the contact part to the non-contact position at a temperature that is lower than a predetermined temperature and displacing the contact part to the contact position at a temperature that is higher than the predetermined temperature.

2. The lighting device according to claim 1, further comprising a support part supporting the contact part via the displacing member such that the displacing member displaces the contact part, wherein the support part is attached to the chassis.

3. The lighting device according to claim 2, wherein the support part is made of metal.

4. The lighting device according to claim 1, wherein:
the displacing member includes
a bias spring configured to bias the contact part toward the non-contact position, and
a shape-memory alloy spring configured to be restored to a previously stored shape at a temperature that is higher than the predetermined temperature and displace the contact part to the contact position against a biasing force of the bias spring.

5. The lighting device according to claim 4, wherein the shape-memory alloy spring and the bias spring are formed in a plate-like shape and the displacing member is configured by overlapping the plate-like shape-memory alloy spring and the plate-like bias spring with each other.

6. The lighting device according to claim 2 or 3, wherein:
the support part includes a tubular part attached to the chassis and an insertion rod inserted into the tubular part;
the contact part is attached to an end of the insertion rod; and
each of the shape-memory alloy spring and the bias spring is a coil spring and is wound around the insertion rod to make the insertion rod displaceable with respect to the tubular part.

7. The lighting device according to claim 6, wherein the insertion rod has an abutting part abutting on the chassis at a temperature that is higher than the predetermined temperature.

8. The lighting device according to claim 1, wherein the displacing member is configured of a bimetal displacing the contact part to the non-contact position at a temperature that is lower than the predetermined temperature and displacing the contact part to the contact position at a temperature that is higher than the predetermined temperature.

9. The lighting device according to claim 1, further comprising a power source supplying driving power to the discharge tube, wherein:
the discharge tube has an electrically connecting part performing electrical connection with the power source; and
the contact part comes in contact with the electrically connecting part.

10. The lighting device according to claim 1, wherein the contact part is configured of an elastic member.

11. The lighting device according to claim 1, further comprising a thermally conductive member thermally connecting the displacing member to the chassis.

12. The lighting device according to claim 1, wherein the discharge tube is configured of a hot cathode tube.

13. A display device comprising:
the lighting device according to claim 1; and
a display panel performing display by use of light from the lighting device.

14. The display device according to claim 13, wherein the display panel is a liquid crystal panel using liquid crystal.

15. A television receiver comprising the display device according to claim 13.
